(19) United States
(12) Patent Application Publication
(10) Pub. No.: US 2008/0003331 A1
(43) Pub. Date: Jan. 3, 2008

(54) Microwavable and Oven-Bakable Coated Food Products

(76) Inventors: Jessie Jianxin Zhao, Plainsboro, NJ (US); Dale Thomas Bertrand, Columbus, NJ (US)

Correspondence Address: HOFFMANN & BARON, LLP, 6900 JERICHO TURNPIKE, SYOSSET, NY, 11791, US

(21) Appl. No.: 10/589,938

(22) PCT Filed: Feb. 18, 2005
(86) PCT No.: PCT/NL05/00121

§ 371 Date: Jun. 29, 2007

Related U.S. Application Data
(60) Provisional application No. 60/546,252, filed on Feb. 20, 2004.

(51) Int. Cl. A23L 1/31; A21D 2/00; A23C 23/00; A23D 7/00; A23J 1/00; A23L 1/01; A23L 1/325; A23P 1/08; A23L 1/03; A23L 1/212; A23L 1/216; A23L 1/22; A23L 1/237

(52) U.S. Cl. 426/92; 426/289; 426/523; 426/580; 426/601; 426/615; 426/622; 426/637; 426/638; 426/649; 426/650; 426/656; 426/96

(57) ABSTRACT

The present invention relates to a batter composition, comprising a dietary fiber and insoluble vegetable protein. Further the invention relates to a food product comprising a batter made form said batter composition, to a method for preparing such a food and to the use of dietary fiber and/or insoluble vegetable protein in a coating for a food product.

### BACKGROUND OF THE INVENTION

This invention relates to a new ingredient composition that when used in frozen coated food products (par fried, raw or full fried) provides a crispy texture after microwaving or oven-baking, similar to that of deep fat fried coated foods.

Coated food products are very popular globally, such as various frozen battered and/or breaded fish, chicken, other meat and vegetable products. It is desirable to have crispy texture after cooking at home or food service for consumption. However, the crispy texture is particularly difficult to achieve when the coated food product is microwaved and/or oven baked and rarely—if ever—as crispy as fried foods. Another major challenge is to maintain the crispy texture after reconstitution for a longer time under heating lamp or at room temperature.

Traditional batters contain various flours, starches, dextrins, etc., which have a tendency to become soggy or tough and chewy after microwaving and/or oven baking the frozen coated foods. Prior art has shown attempts to use a stabilizer composition to pre-treat the meat or vegetable substrate or to use specialized packaging containing various susceptors for microwave heated coated food products. None have used the present novel ingredient composition in the batter system.

### BRIEF SUMMARY OF THE INVENTION

It is a primary object of the invention to provide a (dry) mix for preparing a coated food product having a desirable crisp character when heated for serving by microwave and/or other oven.

It is another object of the invention to provide an improved method for preparing a coated food product for final oven preparation.

It is yet another object of the invention to provide a novel edible product, in particular a product characterized by a crispy texture after microwaving or oven-baking, similar to that of deep fat fried coated foods.

It is yet another object of the invention to provide a method for making an improved edible product characterized by a crispy texture after microwaving and/or oven-baking (similar to that of deep fat fried coated foods).

It has now been found that one or more of these objects and/or one or more objects that are identifiable hereinbelow are achieved by the present invention. In particular the invention provides a new ingredient composition, a method of making and using it and a product improved by it, that when used in frozen coated food products (par fried, raw or full fried) provides a crispy texture after microwaving or oven-baking (similar to that of deep fat fried coated foods).

The composition of the invention, in one aspect, comprises a combination of dietary fiber (soluble and/or insoluble) (preferably potato fiber) and/or insoluble vegetable protein, preferably potato protein.

### DETAILED DESCRIPTION OF THE INVENTION

In particular the invention relates to a batter composition, comprising a dietary fiber and/or -insoluble vegetable protein.

More in particular, the invention relates to a batter composition comprising at least one component selected from the group consisting of dietary fibers from a tuber, dietary fibers from a root, insoluble vegetable proteins from a tuber, insoluble vegetable proteins from a root, insoluble vegetable proteins from a legume and insoluble dairy proteins.

The composition of the invention, in effect, provides a crispy coating. The invention allows the provision of a coating like that of a deep-fried coating in frozen coated food product (par fried, raw or full fried) that is microwave and/or oven heated. The following detailed description will describe this in the context of preferred compositions, but it will be understood by those skilled in the art that other materials and processes that are equivalent in result can be employed with equal facility.

The invention provides a coating mixture which can be applied to food products raw or at any degree of cooking doneness. Foods of this type include many popular items, such as various frozen battered and/or breaded fish, chicken, other meat and vegetable products. The invention provides foods of this type having crispy textures after cooking by the simplest of means by microwave, toaster oven or larger at home or by a food service for consumption.

The present invention overcomes difficulties experienced with achieving a crispy texture when the coated food product is microwaved or oven baked and rarely if ever as crispy as fried foods.

In an embodiment, the invention provides a coated food product of which the coating maintains a crispy texture after reconstitution for a satisfactory long time (an preferably increased time) under heating lamp or at room temperature.

Traditional batters contain various flours, starches, dextrins, etc., which have a tendency to become soggy or tough and chewy after microwaving or oven baking the frozen coated foods. The compositions of the invention can replace these conventional batters by replacing all or a suitable proportion of their ingredients to obtain the desired crispy texture. In this manner the invention avoids the needs of the prior art to use a stabilizer composition to pre-treat the meat or vegetable substrate or to use specialized packaging containing various susceptors for microwave heated coated food products.

Within the context of the invention, a component is in particular considered insoluble if the component (such as the protein, or the protein) has a solubility in water (20° C.) at a pH in the range of 5-10 (optionally buffered, to maintain the pH in the specified range) of about 10 wt. % or less, based on the weight of the solution, preferably about 5 wt. % or less, more preferably about 2.5 wt. % or less. In a much preferred embodiment, the solubility in distilled water (pH 7) at 20° C. of the insoluble component (such as the protein or fiber) is about 10 wt. % or less, preferably about 5 wt. % or less, more preferably about 2.5 wt. % or less. Soluble components are generally any components that have a better solubility than the insoluble component.

The dietary fiber may be any food grade fibrous material, usually of vegetable origin. Such fibers include fibers from roots, from tubers (in particular potato-fibers), from cereals, from legumes and grass-fibers. The fibers may be native or modified fibers. The term modified or derivatized is defined herein as to be chemically, physically, enzymatically or otherwise treated.

The term dietary fiber as used herein is defined as that part of the food (in particular that part of plant origin) that is not digested by the (human) consumer, when eaten. The fiber may be soluble or insoluble (as defined above).

In particular in case the composition is essentially free of insoluble protein, usually at least part of the dietary fiber is insoluble. This is also preferred in case insoluble protein is present.

Suitable fibers include fibers comprising at least one component selected from the group consisting of cellulose, pectin, starch, hemicellulose, glycoproteins, mucilages and lignin. Preferred insoluble fibers include insoluble cellulose fibers, hemicellulose fibers and lignin fibers. Particularly suitable soluble fibers are gums (such as gums of carbohydrate polymers), pectins and mucilages. It should be noted that insoluble compounds may be derivatized to provide soluble fiber, for example an alkyl cellulose fiber such as methyl cellulose fiber.

In an embodiment, the fibers comprise at least 20 wt. %, in particular at least 25 wt. % more preferably at least 30 wt. % of cellulose, hemicellulose and/or one or more other insoluble fibrous components, based on the dry solids content of the fibers.

Preferably, at least part of the dietary fibers are insoluble, more preferably at least about 50 wt. % of the fibers is insoluble (based on the dry weight of the fibers). Highly preferred is an embodiment wherein at least about 70 wt. % of the fibers is insoluble, in particular at least about 80 wt. %. Without being bound by theory, it is contemplated that the insolubility is advantageous with respect to aid in the controlled venting of water vapor from the substrate (the part of the food other than the coating comprising the batter) to the exterior of the coating. This in turn is beneficial with respect to imparting (and/or maintaining) a crisp coating.

The insoluble vegetable protein may be selected from any vegetable source, in particular from a cereal, a fungus, a legume, a tuber or a root. Preferably the insoluble protein is selected from the group consisting of potato proteins, soy proteins, arrow root proteins, cassaya proteins, yam proteins sweet potato proteins and taro proteins. The source (such as cereal, root or tuber) may be a conventional plant material with respect to its amylopectin and amylase content, a high amylopectin variety—such as waxy potato (e.g. potato of which the starch content comprises 95-100% amylopectin)), waxy cassaya (e.g. tapioca comprising 95-100% amylopectin), or a high amylose variety. Particularly good results have been achieved with potato protein. Such protein is commercially available, e.g. Protastar (Avebe) or Protagold Potato Protein (Avebe).

Insoluble soy protein or partially insoluble soy protein is also very suitable. A suitable soy protein is a soy protein obtainable from washing a soy protein composition with an alcohol (in particular ethanol).

Instead of or in addition to insoluble vegetable protein it is also possible to employ an insoluble dairy protein, in particular an insoluble milk protein such as a casein in accordance with the invention

The protein may be obtained in any way from the vegetable source or from dairy, e.g. by acidic denaturation or by thermal coagulation, e.g. as disclosed in U.S. Pat. No. 6,187,367. Ultrafiltration, e.g. as described in WO 97/42834, is also suitable to obtain a protein product. Further suitable technology is known from WO 97/03571 and from WO 02/100187.

In a preferred embodiment, a protein is isolated from vegetable material by thermal coagulation. Thermal coagulation offers several operational advantages, such as the simplicity of the process and the easiness to separate the protein product from the raw material. Thermal coagulation also has a beneficial effect upon several qualitative parameters of the protein product, such as the microbiological quality, the inactivation of enzymes and the loss of anti-nutritional factors (e.g. due to degradation) such as trypsin inhibitors.

A particularly preferred thermal coagulation method is a method wherein the juice of a plant or a part thereof, e.g. potato juice, is subjected to an acid, heat treatment, or a combination thereof. The temperatures used for heat coagulation can be from 23 to 140° C. More preferred are temperatures between 75 and 120° C., and even more preferred are temperatures between 95-110° C. The temperature may be raised for example by direct steam injection or using a heat-exchanger. The pH value can be anywhere in the range of 1-8. Preferably the pH value is between 3.5 and 6.2 and more preferred the pH-value is at about the iso-electric point of the bulk of the potato proteins (usually for potatoes around pH 5).

The thus coagulated flocculant protein material can be separated from the liquid phase by a filter, separator, decanter or the like, yielding a separated wet potato cake, which can subsequently be partially or fully dried.

The amount of the fiber and insoluble protein can be chosen within wide limits. The combined amount of the (insoluble) fiber and the insoluble protein is usually at least 1 wt. %, preferably at least 5 wt. %, more preferably at least 10 wt. %, even more preferably at least 20 wt. % based upon the total dry weight of the composition.

The upper limit is not particularly critical. For practical reasons (such as desired flavoring) the combined amount is preferably about 75 wt. % or less, more preferably about 70 wt. % or less.

In particular by using potato fiber, potato protein—preferably the combination of both—at a (combined) usage level of 1 wt. % to 75 wt. %, preferably from 5 wt. % to 70 wt. %, in the dry batter mix, in addition to one or more ingredients such as used in traditional batters, the end coated food products are able to give much improved crispy texture after microwaving or oven baking, similar to fried food texture. In preferred forms, the composition will contain at least 10 wt. % potato protein and/or potato fiber. Potato dextrins can also be used to good advantage in combination with the potato protein and/or fiber.

In addition, the baking oven or microwave heated products can also remain crispy for a longer period of time at room temperature or under a heating lamp. The coated food products with batters containing fiber and/or insoluble protein can also be fried for added benefit of crispy texture and remain crispy for an extended holding time. Another benefit of using the batter system containing the fiber and/or the insoluble protein is the low carbohydrate level in the batter, that could be used for people who prefer a low carbohydrate diet.

In an embodiment the invention further provides a (dry) batter mix comprising (in addition to the (insoluble) fiber and/or insoluble protein), one or more food ingredients selected from the group consisting of flavors, sweeteners (such as sugars), colors, conditioners, leavening, flours (such as from wheat, corn or rice), spices, herbs, salt and salt substitutes, added nutrients, thickeners (such as gums and other hydrocolloids), acidulents, fats and oils, and the like. The ingredients are preferably essentially dry and can be mixed, with components as needed or desired in any suitable dry blender, such as a V-blender or a ribbon mixer. Agglomeration is useful for many products. If desired, the dry ingredients can be premixed and hydrated for packaging. In some cases it will be desired to mix the ingredients in hydrated or partially hydrated form.

It should be noted that satisfactory results have been achieved without requiring high amounts of oils or fats such as triglycerides, in fact the batter composition may be (essentially) free of fats and oils. If present, at all, the (glyceride) fat plus (glyceride) oil content is usually 15 wt. % based on the dry weight, or less, preferably 10 wt. % or less, more preferably 5 wt. % or less, in particular 1 wt. % or less. Low fat/oil content is in particular advantageous from a dietetic point of view.

The following examples are provided to further illustrate the invention and some of its practical aspects and are not to be taken as limiting in any regard. Unless otherwise indicated all parts and percentages are based on the weight of the composition at the indicated stage in processing.

### EXAMPLE 1

### Bakable and Microwavable Battered and Breaded Fish with Potato Fiber

| BATTER MIX INGREDIENTS | % |
|---|---|
| Hard wheat flour | 10.0 |
| Rice flour | 22.1 |
| Paselli ™FP potato fiber* | 10.0 |
| Perfectamyl ™ B1102 potato dextrin* | 20.0 |
| Perfectamyl ™ FFCA modified potato starch* | 10.0 |
| Perfectacoat ™ QS modified potato starch* | 20.0 |
| Paselli ™EZ 1080 potato starch* | 2.0 |
| Salt | 5.0 |
| Sodium acid pyrophosphate | 0.5 |
| Baking soda | 0.2 |
| Xanthan gum | 0.2 |
| TOTAL | 100.0 |

*AVEBE America Inc, Princeton NJ USA

In a different batch, the Perfectamyl™ B1102 potato dextrin, Perfectamyl™ FFCA modified potato starch and the Perfectacoat™ QS modified potato starch are replaced by 50.0 wt. % PerfectaCrisp™ 101 modified potato starch (Avebe).

Preparation Procedure

Add 990 ml water to 100 g dry batter mix and mix at low to medium speed for 5 min.

Predust partial defrosted frozen or fresh fish pieces with 50% wheat flour and 50% Perfectamyl Gel modified potato starch.

Pass through batter and let drain.

Pass through seasoned homestyle bread crumbs.

Par fry at 190° C. (or 375 F) for 90-110 sec (for end product baking or microwaving). If end product is full fried, par fry at 190° C. (or 375 F) for 50 sec.

Freeze at −20° C.

Reconstitute by baking at 190° C. (or 375 F) for 16-20 min or microwaving for 45-60 sec or till internal temperature reaching 71° C. (or 160 F).

### EXAMPLE 2

### Bakable and Microwavable Battered Chicken Tenders with Potato Fiber and Potato Protein

| BATTER MIX INGREDIENTS | % |
|---|---|
| Hard wheat flour | 10.0 |
| Rice flour | 22.1 |
| Paselli ™FP potato fiber | 5.0 |
| Potato protein | 5.0 |
| Perfectamyl ™ B1102 potato dextrin | 20.0 |
| Perfectamyl ™ FFCA modified potato starch | 10.0 |
| Perfectacoat ™ QS modified potato starch | 20.0 |
| Paselli ™ EZ 1080 potato starch | 2.0 |
| Salt | 5.0 |
| Sodium acid pyrophosphate | 0.5 |
| Baking soda | 0.2 |
| Xanthan gum | 0.2 |
| TOTAL | 100.0 |

In a different batch, the Perfectamyl™ B1102 potato dextrin, Perfectamyl™ FFCA modified potato starch and the Perfectacoat™ QS modified potato starch are replaced by 50.0 wt. % PerfectaCrisp™ 101 modified potato starch (Avebe).

Preparation Procedure

Add 890 ml water to 100 g dry batter mix and mix at low to medium speed for 5 min.

Predust partial defrosted frozen or fresh chicken breast meat with 50% wheat flour and 50% Perfectamyl Gel modified potato starch.

Pass through batter and let drain.

Roll the meat through another powder (50% wheat flour and 50% Perfectamyl Gel).

Batter again and drain.

Par fry at 190° C. (or 375 F) for 90-110 sec (for end product baking or microwaving). If end product is full fried, par fry at 190° C. (or 375 F) for 50 sec.

Freeze at −20 C.

Reconstitute by baking at 190° C. (or 375 F) for 16-20 min or microwaving for 45-60 sec or till internal temperature reaching 71° C. or 160 F.

The above description is intended to allow the person skilled in the art to practice the invention. It is not intended to detail all possible applications, variations and modifications that will be apparent to the skilled worker upon reading the description. It is intended, however, that all such applications, variations and modifications be included in the scope of the invention as defined by the claims which follow.

1. A batter composition, comprising at least one component selected from insoluble vegetable protein and insoluble dietary fibers.

2. A batter composition, comprising an insoluble dairy protein-preferably a casein- and optionally insoluble dietary fiber.

3. A composition according to claim 1, which when used in frozen coated food products provides a crispy texture after microwaving and/or oven-baking, (similar to that of deep fat fried coated foods).

4. A composition according to claim 1, wherein the composition comprises an insoluble dietary fiber selected from the group consisting of cellulose fibers, hemicellulose fibers and lignin fibers, preferably from potato fibers.

5. A composition according to claim 1, comprising a dietary fiber selected from gums, pectin fibers, starch fibers, glycoprotein fibers and mucilages.

6. A composition according to claim 1, wherein the solubility of the protein and/or the insoluble dietary fiber in water (pH 7) at a temperature of 20° C. is 10 wt. % or less, preferably 5 wt. % or less, more preferably 2.5 wt. % or less, based upon the total weight of the solution.

7. A composition according to claim 1, wherein the insoluble protein is a protein from a cereal, a fungus, a legume, a tuber or a root, preferably a protein selected from the group consisting of potato proteins, soy proteins, arrow root proteins, cassaya proteins, yam proteins and taro proteins.

8. A composition according to claim 1, wherein the combined amount of the fibers and the insoluble proteins is at least 1 wt. %, preferably at least 5 wt. %, more preferably at least 10 wt. % based upon the total dry weight.

9. A composition according to claim 1 wherein the combined amount of ingredients other than the fibers and the insoluble proteins is 95 wt. % or less, preferably 90 wt. % or less, more preferably 85 wt. % or less based upon the total dry weight.

10. A composition according to claim 1, comprising less than 85 wt. % based upon the total dry weight digestible carbohydrates.

11. A composition according to claim 1, wherein the composition comprises at least one component selected from the group consisting of (potato) dextrins, flavors (such as sweeteners, spices, herbs, salts, salt substitutes) colors, conditioners, leavenings, flours (such as from wheat, corn, rice), added nutrients, thickeners (such as gums and other hydrocolloids), acidulents, fats and oils.

12. A batter composition, optionally according to claim 1, comprising at least one component selected from the group consisting of dietary fibers from a tuber or a root and insoluble vegetable proteins from a tuber or a root.

13. A batter composition, optionally according to claim 1, comprising at least one component selected from the group consisting of dietary fibers from a potato and insoluble vegetable proteins from a potato or soy.

14. A batter composition according to claim 12, wherein the combined amount of said dietary fibers and said insoluble protein is at least let. %, preferably at least 5 wt. %, more preferably at least 10 wt. %.

15. Coated food product, wherein at least part of the surface of the food product comprises a batter composition according to claim 1 and preferably at least part of the surface comprising the batter composition contains bread crumbs.

16. Coated food product according to claim 15, wherein the coated food product is frozen.

17. Coated food product according to claim 15, comprising a food selected from the group consisting of fish, meat and vegetable products.

18. Coating for a food, comprising a batter composition as defined in claim 1 and preferably bread crumbs.

19. A process for preparing a coated food product comprising coating the food product with a composition according to claim 1.

20. A process for preparing a batter composition according to claim 1, which comprises mixing ingredients comprising at least one component selected from insoluble vegetable protein and insoluble dietary fibers.

21. Method for preparing food, comprising baking and/or microwaving the food product according to claim 15.

22. Use of a dietary fiber and/or insoluble protein, in particular a dairy or vegetable protein, to impart a crispy texture on a microwaved and/or oven-baked food.

23. Use according to claim 22, wherein the fiber is an insoluble dietary fiber selected from the group consisting of cellulose fibers, hemicellulose fibers and lignin fibers, preferably from potato fibers.

24. Use according to claim 22, wherein the protein is a protein having a solubility in water (pH 7) at a temperature of 20° C. is 10 wt. % or less, preferably 5 wt. % or less, more preferably 2.5 wt. % or less, based upon the total weight of the solution.
